(19) United States
(12) Patent Application Publication
(10) Pub. No.: US 2013/0180755 A1
(43) Pub. Date: Jul. 18, 2013

(54) ELECTRIC CABLE FOR NUCLEAR POWER PLANT EASY TO MONITOR CONDITION AND FABRICATION METHOD THEREOF

(71) Applicant: LS CABLE & SYSTEM LTD., ANYANG-CITY (KR)

(72) Inventors: CHAN-YONG PARK, GUNPO-SI (KR); HYUN-WOONG KIM, SEOUL (KR); JAE-BOK LEE, SEONGNAM-SI (KR)

(73) Assignee: LS CABLE & SYSTEM LTD., ANYANG-CITY (KR)

(21) Appl. No.: 13/721,628

(22) Filed: Dec. 20, 2012

(30) Foreign Application Priority Data
Dec. 20, 2011 (KR) 10-2011-0138357

(51) Int. Cl. H01B 7/17

(52) U.S. Cl. CPC H01B 7/17
USPC 174/120 SR; 427/117; 174/120 R

(57) ABSTRACT

An electric cable for a nuclear power plant that allows easy monitoring of its condition for long term use in a nuclear power plant, and a fabrication method thereof is provided. The electric cable for a nuclear power plant includes at least one core having a conductor and an insulating body coating the conductor, and a sheath body surrounding the core, and the insulating body and the sheath body are made of the same composition.

### CROSS-REFERENCE TO RELATED APPLICATION

The present application claims priority to Korean Patent Application No. 10-2011-0138357 filed in the Republic of Korea on Dec. 20, 2011, the disclosures of which are incorporated herein by reference.

### BACKGROUND OF THE DISCLOSURE

1. Field of the Disclosure

The present disclosure relates to an electric cable for a nuclear power plant, and more particularly, to an electric cable for a nuclear power plant that allows easy monitoring of its condition for long term use in a nuclear power plant, and a fabrication method thereof.

2. Description of the Related Art

Among various kinds of cables, an electric cable for a nuclear power plant is installed at various kinds of equipment in a nuclear power plant to transmit power, sensor or control signals.

An electric cable for a nuclear power plant demands physical and chemical characteristics different from general cables since it is continuously exposed to gamma rays having large penetrating and destructive power.

Generally, reliability of an electric cable for a nuclear power plant is tested in consideration of an operating life of over 40 years. The total integrated dose for 40 years reaches 30 to 40 Mrad, and a hanger where a nuclear reactor operates is always maintained under a high-temperature atmosphere so that its continuous use temperature reaches 90° C. For this reason, a much inferior atmosphere is created in comparison to the case of using a general polymer cable.

Further, stimulation runs must be performed in advance to prevent coolant spills, which are considered to be the worst kind of nuclear reactor accident. In this regard, the electric cable should be able to endure a virtual test where a coolant of the nuclear reactor is spilled to expose a large amount of radiations to the electric cable, in which the electric cable is instantly exposed to a super-high temperature/high pressure atmosphere, and a large amount of chemicals is sprayed to the electric cable. The above are considered to be an important process since, if cables for connecting various control devices are not able to endure a virtual test and are damaged, the nuclear reactor may also damage before the nuclear power plant can perform an accident damage minimizing process, which will cause radioactivity to leak in nearby regions, which is the worst kind of accident.

Therefore, an electric cable for a nuclear power plant has important product design standards in terms of a radiation resistance, a heat resistance, a chemical resistance, long-term reliability or the like, and studies are being actively made to meet the standards. Recently, interest in nuclear power plants are going beyond 3-generation and 3.5-generation nuclear power plants to 4-generation nuclear power plants and so studies are being made to construct an infrastructure of a cable which may ensure a very long term operating life of over 60 years when building a new nuclear power plant.

As such a conventional electric cable for a nuclear power plant, an electric cable for a nuclear power plant using a Ethylene Propylene Rubber (EPR) as an insulating body and a Chloro sulfonated polyethylene (CSP) as a sheath body, and an electric cable for a nuclear power plant using a PVC as an insulating body and a Chlorinated Rubber (CR) as a sheath body and including other additives have been developed.

FIG. 1 is a diagram showing a conventional general electric cable for a nuclear power plant.

As shown in FIG. 1, a conventional electric cable 10 for a nuclear power plant basically includes a conductor 1 located at its center portion, an insulating body 2 coating the conductor 1, and a sheath body 3 surrounding the insulating body 2. In this configuration, the insulating body 2 and the sheath body 3 are made of different materials and compositions. The conventional electric cable 10 for a nuclear power plant uses different materials for the insulating body 2 and the sheath body 3, where the sheath body 3 generally uses relatively inexpensive and flexible material.

In addition, along with rapid development of a nuclear power technology such as a 4-generation nuclear power plant (GEN4), the life cycle of operating devices and power, control, instrumentation and sensor cables required for operating the devices are regarded more important in addition to the design of a nuclear power plant. GEN4 has greatly expanded in terms of safety and economic feasibility and is generally known as a nuclear power plant designed to have an operating life of 60 years. The cable is one of the most problematic equipments and unlike other instruments, does not easily separate, dissemble or move. Therefore, the electric cable for a nuclear power plant should ensure its safety continuously as an infrastructure of the power plant.

For the electric cable for a nuclear power plant, a radiation resistance, a heat resistance, a chemical resistance, and long-term reliability are important criterions for design. A cable must ensure a life cycle of 60 years and the safety of the cable must be ensured by monitoring its condition and evaluating its life even after installing the cable at a nuclear power plant. Generally, there are various kinds of electric cables for a nuclear power plant depending on their usages, and cannot be defined to just one. However, they have generally similar features in that at least one conductor 1 and at least one insulating body 2 surrounding the conductor 1 are provided, with an inclusion being added as necessary, the conductor and the insulating body being taped or surrounded by a shield layer, which is coated with the sheath body 3.

It is very important to prevent an electric cable for a nuclear power plant from malfunctioning due to degradation in advance by monitoring a condition of the cable to ensure soundness and estimating a suitable exchange time by means of life evaluation. In order to monitor a condition of an electric cable for a nuclear power plant, chemical, mechanical and electric methods are being used. The chemical or mechanical method is limitedly used for some cables depending on their materials and adopts a destructive manner, and the electric method may not easily quantitatively express a correlation with degradation even though it may be used for all kinds of cables regardless of their materials.

For condition monitoring and life evaluation of an electric cable for a nuclear power plant, various methods such as using a step voltage and high-voltage test (DC high voltage), a dielectric loss measurement, a partial discharge test, a Time Domain Reflectometry (TDR) test, a line resonance analysis, an infrared imaging thermography, an indenter modulus measurement or the like are used.

Among them, the method using an indenter modulus measurement is recently widely used due to its many advantages. The indenter modulus measurement method uses a phenomenon that, as a cable is degraded, the insulating body and the sheath body of the cable become hardened while decreasing a compression ratio. The indenter modulus measurement method measures the degree of compression ratio change, which may be used as a marker expressing degradation. Generally, an elongation ratio may be used as a good evaluation index during initial degradation, and the indenter modulus is used as an excellent evaluation index at a point when a cable is seriously degraded and tends to exhibit a saturated elongation ratio.

The degradation evaluation using the indenter modulus has advantages in that it may be easily applied to a construction site and be easily measured at areas in the reactor container due to its small size and because it can make quick measurements, measurements results can be instantly checked. However, it is disadvantageous in that the sheath body of an electric cable may be measured, but a degradation state of the insulating body located therein cannot. In other words, though the indenter modulus is most useful for monitoring a condition of a cable, particularly for the measurement of the sheath body, it is a fatal drawback that the sheath body should be shed in order to measure and monitor the insulating body.

### SUMMARY OF THE DISCLOSURE

The present disclosure is designed to solve the problems of the prior art, and therefore it is an object of the present disclosure to provide an electric cable for a nuclear power plant with an improved structure capable of monitoring and measuring a condition of not only a sheath body but also an insulating body of an electric cable used for a nuclear power plant, and a fabrication method thereof.

Other objects and advantages of the present disclosure will be understood from the following descriptions and become apparent by the embodiments of the present disclosure. In addition, it is understood that the objects and advantages of the present disclosure may be implemented by components defined in the appended claims or their combinations.

In one aspect of the present disclosure, there is provided an electric cable for a nuclear power plant, which includes at least one core having a conductor and an insulating body coating the conductor; and a sheath body surrounding the core, wherein the insulating body and the sheath body are made of the same composition.

Preferably, the insulating body and the sheath body are made of a halogen-free composition.

Preferably, the insulating body and the sheath body are made of polymer material satisfying radiation resistance for a nuclear power plant.

Preferably, the insulating body and the sheath body are made of polymer material satisfying a heat aging characteristic for a nuclear power plant.

Preferably, the insulating body and the sheath body are made of polymer material which passes a Loss of Coolant Accident (LOCA) test for a nuclear power plant.

Preferably, the insulating body and the sheath body are formed by extruding Halogen Free Cross-Linked Polyolefin (HF-XLPO) polymer composition.

Preferably, the electric cable further includes an inclusion inserted into the sheath body, and the inclusion is preferably made of the same composition as the insulating body and the sheath body.

Further, the electric cable may further include a braid layer.

In addition, the electric cable may further include a non-woven layer.

The electric cable for a nuclear power plant is preferably one selected from power, control, instrumentation, and sensor cables.

The electric cable for a nuclear power plant preferably measures the degree of aging by using an indenter modulus measurement manner.

In another aspect of the present disclosure, there is also provided a fabrication method of an electric cable for a nuclear power plant, which includes preparing a conductor wire; coating a surface of the conductor wire with an insulating body by melting Halogen Free Cross-Linked Polyolefin (HF-XLPO) material and extruding the material toward the conductor wire; and uniting a plurality of extruded insulating bodies, and forming a sheath body surrounding the united insulation bodies by using the same material as the insulating bodies.

Preferably, in the coating step, the extruding process is performed by cross-linking and extruding material by using a Continuous Vulcanization (CV) line.

According to the present disclosure, the insulating body and the sheath body of the electric cable for a nuclear power plant are made of the same composition, so that, when a condition of the cable is monitored, the sheath body and the insulating body may be easily measured and monitored together in real time, to conveniently monitor the condition of the cable, reduce costs for managing and maintaining the electric cable for a nuclear power plant, and ensure the safety of the electric cable.

In addition, since the sheath body is made of the same material as the insulating body, the thermal resistance and radiation resistance applied to the insulating body may be identically implemented at the sheath body, thereby ensuring an elongated life cycle and improved safety of the electric cable for a nuclear power plant.

### BRIEF DESCRIPTION OF THE DRAWINGS

Other objects and aspects of the present disclosure will become apparent from the following descriptions of the embodiments with reference to the accompanying drawings in which:

FIG. 1 is a diagram showing a conventional electric cable for a nuclear power plant;

FIG. 2 is a diagram showing main components of an electric cable for a nuclear power plant according to an embodiment of the present disclosure;

FIG. 3 is a diagram showing an electric cable for a nuclear power plant according to another embodiment of the present disclosure;

FIG. 4 is a graph showing an aging characteristic of the electric cable for a nuclear power plant according to an embodiment of the present disclosure;

FIG. 5 is a diagram showing an electric cable for a nuclear power plant according to another embodiment of the present disclosure;

FIG. 6 is a graph showing an aging characteristic of the electric cable for a nuclear power plant according to another embodiment of the present disclosure;

FIGS. 7 and 8 are graphs showing an aging characteristic of a conventional electric cable for a nuclear power plant;

FIG. 9 is a schematic diagram for illustrating a method for measuring an indenter modulus of the electric cable for a nuclear power plant according to an embodiment of the present disclosure.

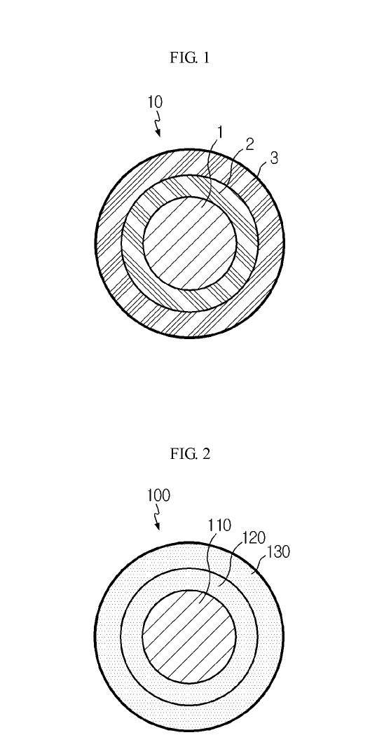

Reference Symbols

100: electric cable for a nuclear power plant
110: conductor
120: insulating body
130: sheath body

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

FIG. 2 is a diagram showing main components of an electric cable for a nuclear power plant according to an embodiment of the present disclosure.

Referring to FIG. 2, the electric cable 100 for a nuclear power plant according to the present disclosure includes a conductor 110, an insulating body 120 insulating and coating the conductor 110, and a sheath body 130 made of the same composition as the insulating body 120 and surrounding the insulating body 120. In other words, in the electric cable for a nuclear power plant, the insulating body 120 coating the conductor 110 is made of material having the same composition as that of the sheath body 130 surrounding the cable 100.

The electric cable 100 for a nuclear power plant may be used as power, control, instrumentation, and sensor cables at a nuclear power plant or an infrastructure of the nuclear power plant. In addition, in the electric cable 100 for a nuclear power plant, the insulating body 120 and the sheath body 130 are formed with the same material by extruding a composition useable in a circumstance exposed to high temperature, high pressure and radiation. For this, the material having the commonly used composition employs polymer material satisfying all the physical and chemical characteristics used at and demanded by the nuclear power plant.

Further, since the electric cable 100 for a nuclear power plant should be excellent in not only heat aging but also radiation resistance (particularly, gamma rays), the insulating body 120 and the sheath body 130 are made of qualified materials which pass a Loss of Coolant Accident (LOCA) test or the like.

In addition, in the electric cable 100 for a nuclear power plant, the insulating body 120 and the sheath body 130 may be made of a halogen-free composition which satisfies the above characteristics without containing halogen material. This is to cope with environment-friendly problems that are on the rise.

In the electric cable 100 for a nuclear power plant, the composition of the insulating body 120 and the sheath body 130 may be, for example, a halogen-free cross-linked polyolefin (HF-XLPO) polymer compound which satisfies the above characteristics.

The electric cable 100 for a nuclear power plant including the insulating body 120 and the sheath body 130 made of the same material may predict the degree of degradation of the insulating body 120 made of the same material by measuring an indenter modulus of the sheath body 130 according to an indenter method using a compressibility coefficient without shedding or destroying the sheath body 130, when monitoring or measuring a condition of the cable.

Here, the indenter method (see FIG. 9) is a method for evaluating degradation and aging by measuring an indenter modulus of the electric cable 100 for a nuclear power plant. The indenter method is a nondestructive method for evaluating degradation of the insulating body 120 and the sheath body 130 of the cable by measuring a compressive modulus. This method is performed by applying a force 530 to compress a specimen toward a support block 520 at a constant speed while measuring force. The indenter modulus is obtained by measuring the force while the sheath of the cable 100 is pressed toward the support block 520 at a predetermined speed by an instrumented anvil 510 having a predetermined shape. If the force reaches a predetermined limit, the test is completed, and the instrumented anvil 510 is removed from the cable sheath. The indenter modulus may be obtained by dividing the change of force by the change of position while the anvil 510 is moving inwards. When measuring the indenter modulus, a correction function according to temperature is required, and the test is mostly performed in the range of 20 to 35° C.

Along with it, properties of the insulating body 120 and the sheath body 130 made of the same material satisfying the above characteristics will be described.

First, in case of an EPR/CSP cable frequently used in the past, EPR is generally used for the insulating body, and CSP is generally used for the sheath body. Demanded properties of the insulating body and the sheath body specified in the NEMA standards are different from each other, and as shown in Table 1 below, the demanded properties of the sheath body are generally higher than the demanded properties of the insulating body.

TABLE 1

| | | test condition | unit | insulating body | sheath body |
|---|---|---|---|---|---|
| normal temperature | tensile strength | normal | kg_{f}/mm² | 0.84↑ | 1.5↑ |
| | elongation rate | temperature | % | 200↑ | 300↑ |
| | | (25° C.) | | | |
| heat resistance | residual tensile | 100° C. | % | — | 85↑ |
| | strength | 168 hrs | | | |
| | residual | | % | — | 75↑ |
| | elongation | | | | |
| | residual tensile | 121° C. | % | 80↑ | — |
| | strength | 168 hrs | | | |
| | residual | | % | 80↑ | — |
| | elongation | | | | |
| oil resistance | residual tensile | 121° C. | % | — | 75↑ |
| | strength | 18 hrs | | | |
| | residual | | % | — | 75↑ |
| | elongation | | | | |

As shown in Table 1 above, since EPR material conventionally applied to an insulating body does not satisfy properties of the sheath body due to the fundamental limits of the material, the insulating body may not be applied to the sheath body. In addition, CSP used for the sheath body generally includes lead for radiation resistance, but the lead included in the CSP does not give so great influence when shielding radiation.

In addition, as environment-friendly problems are on the rise over the world, the demand for halogen-free material not using a halogen substance is increasing. Therefore, CSP having a chlorinated group is not suitable for the electric cable for a nuclear power plant any more. Therefore, CSP having the above properties should be improved.

According to an embodiment of the present disclosure, an electric cable and property conditions capable of satisfying environment-friendly characteristics and properties of both the insulating body and the sheath body by using halogen-free XLPO material will be proposed instead of a conventional EPR/SCP cable.

Since EPR or CSP are weak against the exposure to radiation, standards for a tensile strength and an elongation rate are specified very high in order to prevent breaking or cracking when the cable is bent after being exposed to radiation. However, after studying the XLPO material, it has been found that all Design Basis Event (DBE) tests required for the electric cable for a nuclear power plant may be passed if properties are within specific ranges.

TABLE 2

| | | | | insulating |
|---|---|---|---|---|
| | | test condition | unit | body/sheath body |
| normal | tensile strength | normal temperature | kg_{f}/mm² | 1.0-1.4 |
| temperature | elongation rate | (25° C.) | % | 130-250 |
| oil resistance | residual tensile | 121° C., 18 hrs | % | 70↑ |
| | strength | IRM902 (ASTM#2oil) | | |
| | residual elongation | | % | 70↑ |
| radiation | residual tensile | 2.9 * 10⁶ Gy | % | 80↑ |
| resistance | strength | | | |
| (γ rays) | residual elongation | | % | 10↑ |

In case of a normal temperature tensile strength, the European IEC 60780 standards specify that an insulating body and a sheath body must have a tensile strength of 0.9 kg_{f}/mm² or above and an elongation rate of 120% or above. However, at 1.0 kg_{f}/mm² or below, it has been found that the cable cannot play its role properly in a circumstance of a nuclear power plant exposed to heat and radiation and cannot endure a physical force applied in operation. It has been revealed that the maximum value, 1.4 kg_{f}/mm², is a limit of the XLPO material.

Along with it, if the insulating body and the sheath body have a normal temperature elongation rate of 130% or below, a crack is generated when the cable is bent after being exposed to heat, radiation and DBE. In addition, since XLPO is not a rubber-like material, the maximum elongation rate of polyolefin (PO) based material is about 250%, and so the upper limit of the elongation rate may not exceed 250%.

Regarding the oil resistance property, when properties are measured by using IRM 902 (ASTM #2 oil) after aging at 121° C. for 18 hours, the role of the sheath body may be performed if the tensile strength and the elongation rate are 70% or above in comparison to initial properties, which may be regarded as being suitable for the electric cable for a nuclear power plant.

In addition, regarding the exposure to radiation, which is most important for the electric cable for a nuclear power plant, after an amount of 2.9×10⁶ Gy is instantly exposed to γ (gamma)-rays, if the tensile strength is 80% or above and the elongation rate is 10% or above in comparison to initial properties, it is regarded that all DBE demanded after the exposure to radiation are passed.

If the properties are not satisfied, a crack is generated in a re-bending test after the LOCA test. Therefore, in the electric cable for a nuclear power plant according to the present disclosure, the insulating body and the sheath body are made of the same material satisfying the properties specified in Table 2.

FIG. 3 is a diagram showing an electric cable for a nuclear power plant according to another embodiment of the present disclosure.

Referring to FIG. 3, the electric cable 200 for a nuclear power plant according to the present disclosure includes a plurality of insulation-coated cores. In other words, the electric cable 200 includes a plurality of cores, each having a conductor 210 and an insulating body 220 coating the conductor 210, and a sheath body 230 surrounding the plurality of cores and made of the same composition as the insulating body 220.

As shown in FIG. 3, the electric cable for a nuclear power plant may be provided as a wire form having a single-strand core (see FIG. 3) or as a multi-core cable form having a plurality of cores surrounded by the sheath body 230 located at the outermost position as shown in FIG. 3.

Along with it, the electric cable 200 for a nuclear power plant may further include a braid layer (not shown) located in the outermost sheath body 230 and surrounding the plurality of cores. Further, the electric cable 200 for a nuclear power plant may further include a non-woven layer (not shown) provided in the outermost sheath body 230 with a shape surrounding the plurality of cores. The electric cable 200 for a nuclear power plant may also be configured to include both the braid layer and the non-woven layer in the outermost sheath body 230.

In addition, the electric cable 100 for a nuclear power plant according to an embodiment of the present disclosure, which has a single-strand core as shown in FIG. 2, may also include the braid layer and the non-woven layer in the sheath body 130.

Moreover, the cable shown in FIG. 3 may be used as a control cable in the nuclear power plant infrastructure. In other words, the control cable may representatively be configured so that seven cores, each having a conductor 210 coated with an insulating body 220, are united and surrounded by a sheath body 230 made of the same composition as the insulating body 220.

The aging characteristic of the electric cable 200 for a nuclear power plant according to an embodiment of the present disclosure, where the insulating body 220 and the sheath body 230 are made of the same composition, will be described in respect to the insulating body 220 and the sheath body 230, respectively.

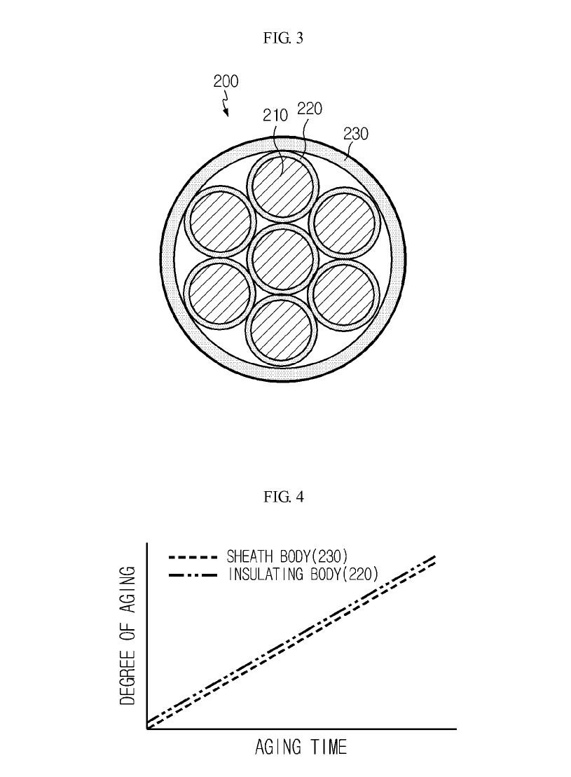

FIG. 4 is a graph showing an aging characteristic of the electric cable for a nuclear power plant according to an embodiment of the present disclosure.

Referring to FIG. 4, in the electric cable 200 for a nuclear power plant according to the embodiment of the present disclosure, which has a plurality of cores, aging characteristics of the insulating body 220 and the sheath body 230 according to an aging time may be checked from the graph.

In the graph, it may be found that the changes of aging of the insulating body 220 and the sheath body 230 according to time are substantially identical. In other words, the aging characteristics are similar since the insulating body 220 and the sheath body 230 are made of the same composition.

Since the sheath material of the sheath body 230 and the insulating material of the insulating body 220 exhibit the same aging slope (aging degree/aging time), only if the difference of times when the sheath body 230 and the insulating body 220 start aging, the degree of aging of the insulating body 220 may be estimated by measuring an indenter modulus of the sheath body 230 based on their correlation, which allows a condition of the cable to be easily monitored and measured.

In addition, since the sheath body 230 and the insulating body 220 should have the same composition, the flame retardance of the sheath body 230 serving as a sheath of the cable should be provided to the insulating body 220.

FIG. 5 is a diagram showing an electric cable for a nuclear power plant according to another embodiment of the present disclosure.

Referring to FIG. 5, the electric cable 300 for a nuclear power plant according to another embodiment of the present disclosure includes an additional inclusion 340 together with plurality of insulated and coated cores. In other words, the electric cable 300 for a nuclear power plant includes a plurality of cores, each having a conductor 310 and an insulating body 320 coating the conductor 310, a sheath body 330 surrounding the plurality of cores and made of the same composition as the insulating body 320, and an inclusion 340 inserted into the sheath body 330.

As shown in FIG. 5, the electric cable 300 for a nuclear power plant according to the present disclosure has a plurality of cores, each having a conductor 310 and an insulating body 320 coating the conductor 310, and an inclusion 340 disposed around the plurality of cores, and an outermost sheath body 330 surrounding the cores and the inclusion 340, and the insulating body 320 and the sheath body 330 are made of the same composition.

Similar to the configuration depicted in FIG. 3, the electric cable 300 for a nuclear power plant may further include a braid layer (not shown) and/or a non-woven layer in the outermost sheath body 330 surrounding the plurality of cores and the inclusion 340. The inclusion 340 is inserted in a wire form along the longitudinal direction of the cable and used for reinforcing mechanical and physical characteristics of the cable.

The inclusion 340 may be made of material or composition with excellent mechanical and physical characteristics, and may also be made of the same composition as the insulating body 320 and the sheath body 330. If the inclusion 340 is made of the same composition, a state of the entire cable may be monitored more easily.

In addition, the cable shown in FIG. 5 may be used as an instrumentation cable in the nuclear power plant infrastructure. Here, the instrumentation cable may be configured by, for example, uniting two cores with two inclusions 340, applying a braid layer and a non-woven layer thereto, and then surrounding them by the sheath body 330 made of the same composition as the insulating body 320.

An aging characteristic of the electric cable 300 for a nuclear power plant according to another embodiment of the present disclosure, where the insulating body 320 and the sheath body 330 are made of the same composition and the inclusion 340 is added, will be described in respect of the insulating body 320 and the sheath body 330, respectively.

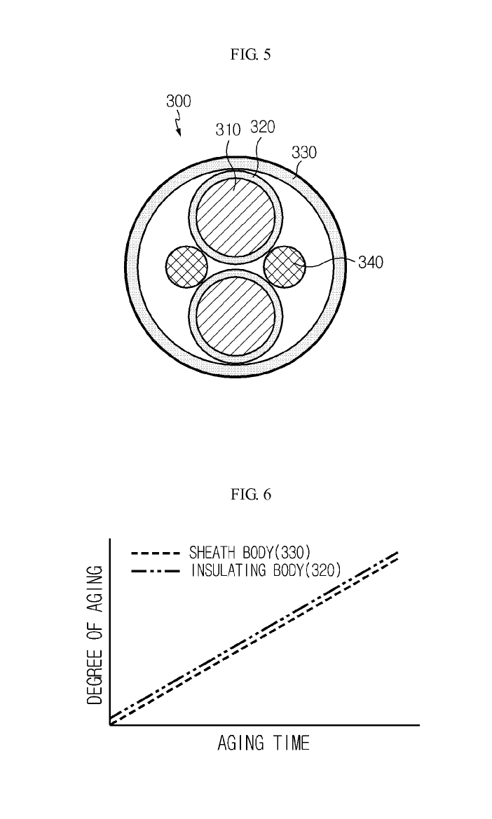

FIG. 6 is a graph showing an aging characteristic of the electric cable for a nuclear power plant according to another embodiment of the present disclosure.

Referring to FIG. 6, an aging characteristic of the electric cable 300 for a nuclear power plant according to another embodiment of the present disclosure, which has a plurality of cores and inclusions, may be checked through a graph, in respect of the insulating body 320 and the sheath body 330, respectively.

In the graph, similar to the result depicted in FIG. 4, it may be found that aging characteristics of the insulating body 320 and the sheath body 330 according to an aging time are very similar to each other. Since the insulating body 320 and the sheath body 330 are made of the same composition, their aging characteristics are also similar to each other.

In this embodiment, similar to the former embodiment, since the sheath material of the sheath body 330 and the insulating material of the insulating body 320 exhibit the same aging slope (aging degree/aging time), only if the difference of times when the sheath body 330 and the insulating body 320 start aging, the degree of aging of the insulating body 320 may be estimated by measuring an indenter modulus of the sheath body 330 based on their correlation, which allows a condition of the cable to be easily monitored and measured. In addition, if the inclusion 340 is made of the same composition as the insulating body 320 and the sheath body 330, the degree of aging of the inclusion 340 may also be estimated in the same way as described above.

According to the present disclosure, a method for fabricating an electric cable for a nuclear power plant, which includes an insulating body and a sheath body made of the same composition is provided.

The method for fabricating an electric cable for a nuclear power plant according to the present disclosure includes preparing and preheating a conductor wire, extruding a composition commonly sued for an insulating body and a sheath body to coat the conductor wire with the insulating body, rapidly cooling the extruded insulating body, uniting a plurality of cores coated with the insulating body, and forming a sheath body at the outermost portion of the cable to surround the plurality of united cores by using the same composition as the insulating body.

For the conductor wire, a 2.5 SQMM conductor is prepared and applied.

For the composition of the material used for the insulating body and the sheath body, halogen-free polyolefin is used, which is melted and then extruded toward the conductor wire to coat the surface of the conductor wire and thus form the insulating body.

Here, the extruding process for coating the conductor wire with the conductor wire uses a Continuous Vulcanization (CV) line in order to cross-link and extrude the material, and thus the insulating body is formed with halogen-free cross-linked polyolefin (HF-XLPO). The process of forming the sheath body may also be performed in the same way.

### COMPARATIVE EXAMPLE

In case of a conventional electric cable for a nuclear power plant, for example a control cable, an EPR material is extruded on a 2.5 SQMM conductor to form an insulating layer, and seven insulation-coated strands are united. After that, a sheath layer is formed on the insulating layer by using a general inexpensive CSP material. In this way, a cable is completely fabricated.

In the conventional electric cable for a nuclear power plant, the insulating layer and the sheath layer are made of different materials and compositions. Therefore, the insulating layer and the sheath layer may have different characteristics, which results in different aging characteristics.

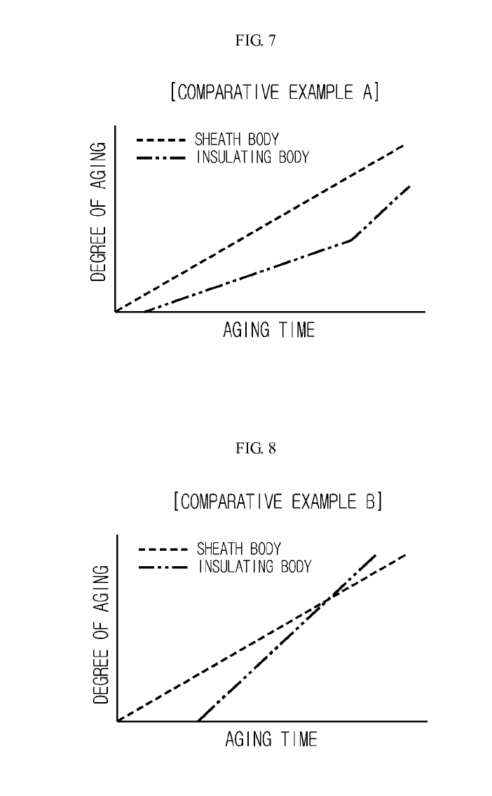

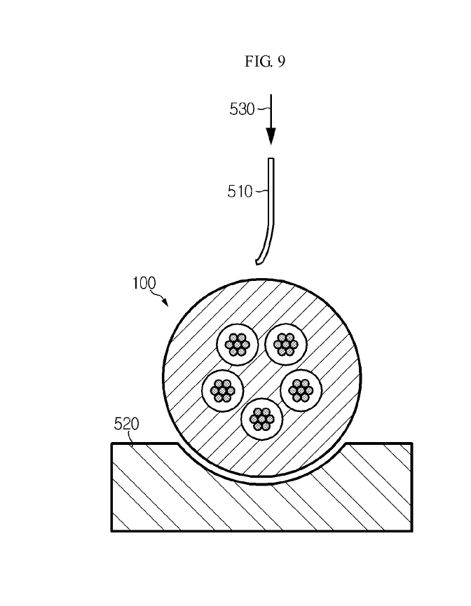

FIGS. 7 and 8 are graphs showing an aging characteristic of a conventional electric cable for a nuclear power plant.

Referring to FIGS. 7 and 8, in the conventional electric cable for a nuclear power plant having an insulating layer and a sheath layer made of different materials, aging characteristics of the insulating layer and the sheath layer according to an aging time may be checked through graphs.

In the graphs, in the conventional cable, the material of the sheath layer and the material of the insulating layer exhibit different aging slopes (aging degree/aging time).

In other words, in Comparative Example A, it may be found that the sheath layer and the insulating layer exhibit different aging slopes according to an aging time, and the insulating layer has an inflection point in a certain region.

In addition, in Comparative Example B, it may be found that the sheath layer and the insulating layer exhibit different aging slopes according to an aging time, and the slope is reversed in a certain region.

Moreover, since the aging of the sheath layer influences the insulating layer in the conventional cable, the aging speed of the insulating layer also increases. Therefore, it is difficult to determine the degree of aging of the insulating layer based on the degree of aging of the sheath layer, and such determination may cause a fatal safety error.

As a result, it is not easy to monitor a condition of a conventional cable and estimate the degree of aging thereof, and a lot of effort and cost are required for maintaining the conventional cable.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

What is claimed is:

1. An electric cable for a nuclear power plant, comprising:
at least one core having a conductor and an insulating body coating the conductor; and
a sheath body surrounding the core,
wherein the insulating body and the sheath body are made of the same composition.

2. The electric cable for a nuclear power plant according to claim 1,
wherein the insulating body and the sheath body are made of a halogen-free composition.

3. The electric cable for a nuclear power plant according to claim 1,
wherein the insulating body and the sheath body are made of polymer material satisfying radiation resistance for a nuclear power plant.

4. The electric cable for a nuclear power plant according to claim 1,
wherein the insulating body and the sheath body are made of polymer material satisfying a heat aging characteristic for a nuclear power plant.

5. The electric cable for a nuclear power plant according to claim 1,
wherein the insulating body and the sheath body are made of polymer material which passes a Loss of Coolant Accident (LOCA) test for a nuclear power plant.

6. The electric cable for a nuclear power plant according to claim 1,
wherein the insulating body and the sheath body are made of material having a tensile strength in the range of 1.0 kg_{f}/mm² to 1.4 kg_{f}/mm² and an elongation rate in the range of 130% to 250% at a normal temperature.

7. The electric cable for a nuclear power plant according to claim 1,
wherein the insulating body and the sheath body are made of material having a residual tensile strength of 70% or above and a residual elongation of 70% or above, under a circumference of being exposed to a high-temperature oil for a long time.

8. The electric cable for a nuclear power plant according to claim 1,
wherein the insulating body and the sheath body are made of material having a residual tensile strength of 80% or above and a residual elongation of 10% or below, under a circumference of being instantly exposed to a predetermined amount of radiation.

9. The electric cable for a nuclear power plant according to claim 1,
wherein the insulating body and the sheath body are formed by extruding Halogen Free Cross-Linked Polyolefin (HF-XLPO) polymer composition.

10. The electric cable for a nuclear power plant according to claim 1, further comprising an inclusion inserted into the sheath body.

11. The electric cable for a nuclear power plant according to claim 10,
wherein the inclusion is made of the same composition as the insulating body and the sheath body.

12. The electric cable for a nuclear power plant according to claim 1, further comprising a braid layer surrounding the core.

13. The electric cable for a nuclear power plant according to claim 1, further comprising a non-woven layer surrounding the core.

14. The electric cable for a nuclear power plant according to claim 1,
wherein the electric cable for a nuclear power plant is one selected from power, control, instrumentation and sensor cables.

15. The electric cable for a nuclear power plant according to claim 1,
wherein the electric cable for a nuclear power plant measures the degree of aging by using an indenter modulus measurement manner.

16. A fabrication method of an electric cable for a nuclear power plant, comprising:
preparing a conductor wire;
coating a surface of the conductor wire with an insulating body by melting Halogen Free Cross-Linked Polyolefin (HF-XLPO) material and extruding the material toward the conductor wire; and
uniting a plurality of extruded insulating bodies, and forming a sheath body surrounding the united insulation bodies by using the same material as the insulating bodies.

17. The fabrication method of an electric cable for a nuclear power plant according to claim 16,
wherein, in the coating step, the extruding process is performed by cross-linking and extruding material by using a Continuous Vulcanization (CV) line.
